(19) United States
(12) Patent Application Publication
(10) Pub. No.: US 2014/0229894 A1
(43) Pub. Date: Aug. 14, 2014

(54) SYSTEMS AND METHODS FOR GENERATING PLAYLISTS BASED ON USER FEEDBACK

(71) Applicant: Daisy, LLC, (US)

(72) Inventors: Fredric Vinna, Stockholm (SE); Robert Sheridan, Los Angeles, CA (US); Michael Trent Reznor, Beverly Hills, CA (US)

(73) Assignee: Daisy, LLC, Santa Monica, CA (US)

(21) Appl. No.: 13/765,584

(22) Filed: Feb. 12, 2013

(51) Int. Cl. G06F 3/0482

(52) U.S. Cl. CPC G06F 3/0482
USPC 715/810

(57) ABSTRACT

Systems and methods are provided for generating playlists within a music service. According to certain aspects, the systems and methods enable users to select one or more seed songs. The systems and methods identify a plurality of songs that are similar to the one or more seed songs and present, to the user, the playlist with the seed songs and the plurality of identified songs. Further, the systems and methods enable the users to provide positive or negative feedback for any of the songs on the playlist. According to embodiments, the systems and methods modify the songs of the playlist based on the provided feedback.

### FIELD

This application generally relates to systems and methods for implementing and managing a music service. In particular, the application relates to platforms and techniques for generating playlists within the music service based on song similarities, listening histories, and user-selected song feedback.

### BACKGROUND

Music services are gaining in popularity as more consumers seek immediate access to comprehensive music libraries. For example, instead of purchasing individual copies of songs or albums (e.g., CDs), consumers can register with various music services to access music offered by the music services. Particularly, various music services and platforms enable users to download or stream specific songs, albums, or playlists to desktop applications or mobile devices. However, there are deficiencies in existing music services and platforms.

In particular, the existing music services and platforms do not enable users to efficiently or effectively discover and organize new music and/or music that could be of potential interest to the users. Particularly, if a user wants to build or otherwise access a playlist, the user must manually add all of the songs to the playlist or otherwise access a playlist that is pre-constructed by another user. Further, some music services stream music to a user that is similar to music selected by the user, such as via a radio feature. However, the user has no control of which similar songs are selected by the music service and in some cases the user is further limited in controlling the playback of the similar songs.

Accordingly, with the advent and popularity of music services offering users the ability to expand their access to music libraries, there is an opportunity for systems and methods for enabling users to generate playlists that include relevant and desired music. Particularly, there is an opportunity for systems and methods for enabling users to build playlists by providing feedback for identified songs.

### SUMMARY OF THE INVENTION

The application is defined by the appended claims. This description summarizes aspects of the embodiments and should not be used to limit the claims.

The application is intended to solve the above-noted business and technical problems by providing systems and methods for generating playlists for users. In one embodiment, a method for generating a playlist is provided. The method receives, from a user via an interface, a selection of a seed song to add to the playlist. The method identifies a plurality of songs to add to the playlist, wherein the plurality of songs are similar to the seed song, and presents the playlist to the user, the playlist comprising the seed song and the plurality of songs. Further, the method receives, from the user, feedback for one of the plurality of songs and modifies the playlist according to the feedback for the one of the plurality of songs.

In another embodiment, an electronic device capable of generating a playlist for a user of a music service is provided. The electronic device comprises an interface capable of receiving inputs from the user and presenting information to the user, and a processor coupled to the user interface. The processor is configured to receive, from the user via the interface, a selection of a seed song to add to the playlist, and identify a plurality of songs to add to the playlist, wherein the plurality of songs are similar to the seed song. Further, the processor is configured to present the playlist to the user via the interface, the playlist comprising the seed song and the plurality of songs. Moreover, the processor is configured to receive, from the user, feedback for one of the plurality of songs, and modify the playlist according to the feedback for the one of the plurality of songs.

In a further embodiment, a non-transitory computer readable medium comprising computer instructions embodied thereon is provided. The computer instructions cause a processor to cause a processor to receive, from a user via an interface, a selection of a seed song to add to a playlist and identify a plurality of songs to add to the playlist, wherein the plurality of songs are similar to the seed song. Further, the computer instructions cause the processor to present the playlist to the user via the interface, the playlist comprising the seed song and the plurality of songs. Moreover, the computer instructions cause the processor to receive, from the user, feedback for one of the plurality of songs, and modify the playlist according to the feedback for the one of the plurality of songs.

### BRIEF DESCRIPTION OF THE DRAWINGS

For a better understanding of the invention, reference may be had to embodiments shown in the following drawings in which:

FIG. 1 is a block diagram illustrating an exemplary environment for implementing and managing a music service, in accordance with embodiments.

FIG. 2 illustrates an exemplary interface associated with a music service application, in accordance with embodiments.

FIG. 3 illustrates an exemplary interface associated with a music service application, in accordance with embodiments.

FIGS. 4A-4D illustrate exemplary interfaces associated with a music service application, in accordance with embodiments.

FIG. 5 is a diagram of an exemplary device configured to interface with a music service, in accordance with embodiments.

FIG. 6 is a diagram of an exemplary music service server, in accordance with embodiments.

FIG. 7 is a flow diagram depicting playlist generation techniques, in accordance with embodiments.

### DETAILED DESCRIPTION OF PREFERRED EMBODIMENTS

While the invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

In accordance with one or more principles of the invention, systems and methods are provided for generating playlists based on user ratings or feedback within a music service. According to embodiments, the music service can be implemented as part of an electronic device, server computer, and/or other hardware device with various combinations of hardware and software components. In operation, the music service enables the user to locate and select one or more songs to be “seed” songs for a playlist. The music service identifies a plurality of songs that are similar (or in any way related) to the seed songs and adds the plurality of songs and the seed songs to the playlist. In embodiments, the music service enables the user to select one or more of the plurality of songs and, in response to the selecting, the music service effectively converts the selected song(s) into an additional seed song(s). Further, in response to the selecting, the music service identifies one or more additional songs that are similar to the seed songs (i.e., the original seed songs and the converted additional seed song(s)) and adds the additional songs to the playlist. The music service further enables the user to selectively remove one or more songs from the playlist and, in some embodiments, replaces the removed song(s) with additional song(s) that is similar to any of the seed songs. The music service enables the user to further build the playlist via these selecting and rating/feedback functionalities.

In some embodiments, the music service can maintain a specified amount of songs on the playlist. More particularly, in this embodiment, the music service removes one song from the playlist for every song added to the playlist. In this case, the music service can remove one or more of the non-seed songs while leaving the seed songs intact on the playlist. In other embodiments, the music service can add various amounts of songs to a playlist in response to the user converting existing songs of the playlist into seed songs. In further embodiments, the music service enables the user to add songs to the playlist without selecting or rating any of the existing songs of the playlist. In this embodiment, the music service identifies songs that are similar to the existing seed songs of the playlist and adds the identified songs to the playlist.

As used herein, a “music service” can be understood to be any service, platform, application, or the like that enables a set of users to access and manage media data such as music file, among other functionalities. In some embodiments, the set of users can register with the music service. Further, as used herein, a “playlist” can be understood to be a listing, indication, or aggregation of one or more songs, tracks, and/or other media data files accessible to and manageable by one or more users, and from which the one or more users can select one or more songs for playback. In some cases, the media data files can be accessible locally to the device from which the user is accessing the playlist. In other cases, the media data files can be accessible via streaming from a remote server or from other devices connected to the device via a network.

It should be understood that any music identifying, determining, locating, retrieving, providing or the like can be facilitated by an electronic device singularly, or by the electronic device in communication with a server, such as a music service server. For example, the electronic device (e.g., smartphone, tablet computer, notebook computer, etc.) can request a server to locate one or more songs based on various parameters communicated from the electronic device to the server. Further, the server can provide any located songs to the electronic device for playlist generation functionalities and/or for playback by a user. Further, both the electronic device and the server can execute a music service or similar music service module to implement the functionalities as discussed herein.

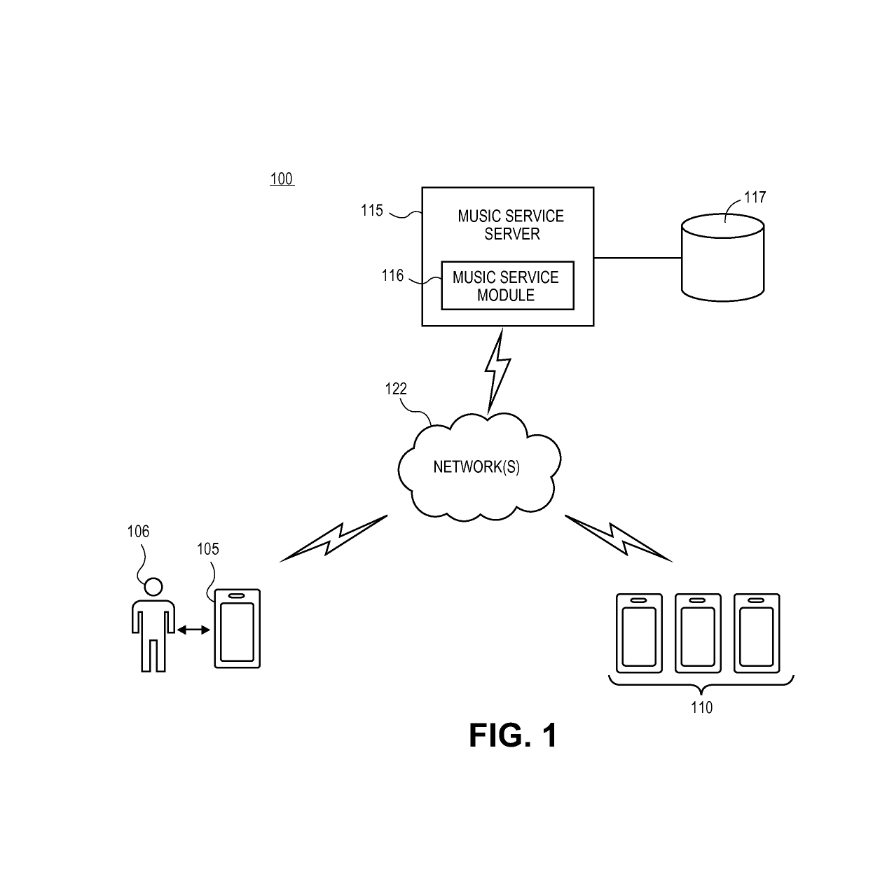

FIG. 1 depicts an environment 100 comprising components and entities of the embodiments as discussed herein. It should be appreciated that the environment 100 is merely exemplary and can comprise fewer or more components and entities, as well as other various combinations of components and entities.

As shown in FIG. 1, the environment 100 comprises a device 105 configured to communicate with a music service server 115. In embodiments, it should be understood that the device 105 can be any type of device such as, for example, a smart phone, a notebook or desktop computer, a tablet device, a personal data assistant (PDA), or the like, comprising any type of hardware or software components, or combinations thereof. The device 105 can execute a music service application 107 configured to facilitate the functionalities as discussed herein. As shown in FIG. 1, a user 106 can interface with the device 105 and/or the music service application 107 thereof to interface with and manage various functionalities associated with the components of the environment 100. The music service server 115 can comprise a combination of hardware or software components (such as a music service module 116), or combinations thereof, configured to support the facilitation of a music service and the playlist generation techniques as described herein. In some embodiments, the user 106 of the device 105 can register for an account or a registration with an associated music service and the music service server 115 and components thereof can provide music data to the device 105 in accordance with a subscription of the user 106. For example, in some cases, the user 106 can select to download songs, tracks, and/or other media data files from the music service server 115 to the device 105. In other cases, the music service server 115 can stream songs, tracks, playlist files including songs, and/or other media data files to the device 105 for access and consumption by the user 106.

In embodiments as shown, the music service server 115 can couple to storage 117 that can be configured to store data associated with the music service server 115. For example, the storage 117 can store any associated music data as well as data related to subscriptions and other account information for users of the music service server 115. The device 105 can connect to the music service server 115 via a network 122 such as, for example, a wide area network (WAN), a local area network (LAN), or other networks. The network 122 can facilitate any type of wireless data communication via any standard or technology (e.g., GSM, CDMA, TDMA, WCDMA, EDGE, OFDM, GPRS, EV-DO, WiMAX, WiFi, Bluetooth, UWB, and others). More particularly, the device 105 can send data to and receive data from the music service server 115 via the network 122. For example, the music service server 115 can receive song feedback ratings, song selections, and seed song conversion requests from the device 105 and/or the user 106 and can transmit or stream music data to the device 105 according to the ratings and selections.

As shown in FIG. 1, the environment 100 can further comprise a set of additional devices 110 that can also be configured to connect to the music service server 115 via the network 122. Each of the set of additional devices 110 can be associated with a set of additional users of the music service implemented by the music service server 115. More particularly, each of the set of additional users can have an associated account with the music service or can otherwise register with the music service. In embodiments, the device 105 can be configured to connect to and/or exchange data with the set of additional devices 110 via the network 122. Any of the additional devices 110 can send song data to the device 105 via the network 122.

Although not shown in FIG. 1, the environment 100 can further comprise a satellite such as a global positioning system (GPS) satellite that can be configured to provide GPS information to the device 105 via a GPS network. In particular, the device 105 can be configured with a GPS receiver chip that can calculate GPS coordinates to locate the device 105, determine a venue or specific location in which the device 105 is located, and perform other functionalities.

According to implementations, the music service server 115, the device 105, and the set of additional devices 110, and components thereof, can facilitate the management of music subscriptions of the users of the respective devices 105, 110. More particularly, the music service server 115 (and the music service module 116 thereof), the device 105 (and the music service application 107 thereof), and/or the set of additional devices 110 can generate playlists and provide songs of the playlists to the users of the device 105 and/or the set of additional devices 110. Particularly, users of the device 105 and/or the set of additional devices 110 can interface with respective devices 105, 110 to initiate a music service or application and control the functionalities of the music service (such as inputting playlist generation parameters and providing feedback associated with the playlists). The device 105 and/or the set of additional devices 110 can communicate with the music service server 115 to identify songs based on the playlist generation parameters and the feedback, and the device 105 and/or the set of additional devices 110 can provide indications of the identified songs to the users. In some embodiments, the user can select to play a playlist, at which point the music service server 115 can retrieve the appropriate songs from the storage 117 and provide (e.g., by streaming) the songs to the appropriate device 105, 110. In some embodiments, one or more of the songs can be played from a local cache of the appropriate device 105, 110. In further embodiments, one or more of the songs can be retrieved via a peer-to-peer (P2P) network among the device 105 and the set of additional devices 110.

According to embodiments, each of the songs associated with the music service can have one or more attributes. For example, the attributes can encompass structures, compositions, rhythms, meters, roots, tonalities, instrumentations, leanings or stylings, recording techniques, influences, types of instrumental ensembles, types of individual instruments, lyrical content, vocal presences, and/or other elements. The music service can identify the attributes of the songs and associate the attributes with the songs. Further, the music service can determine which songs are similar to one another, and to what degree or extent. For example, the music service can determine, based on one or more of the attributes, that songs by a certain artist or band are similar to songs by another artist or band. In some embodiments, the music service can maintain similarity degrees or levels among songs whereby, for example, Song A is more similar to Song B than Song A is to Song C. Further, in embodiments, the music service can update similarity and attribute information based on user ratings and/or other factors. In some embodiments, the attributes can be assigned to songs manually by one or more users or administrators. Collectively, these described functions and benefits can be implemented within a music service facilitated by and accessible to the components of the environment 100. It should be appreciated that other similarity determination functionalities, algorithms, or techniques are envisioned.

In some embodiments, a user or administrator can organize or “curate” a selection of songs and apply attributes to the songs as the user or administrator deems fit. In particular, the user or administrator can mark two or more songs as similar to one another, can apply attributes or tags to various songs based on various factors (e.g., “upbeat,” “slow,” “country,” etc.), can create lists that contain similar songs, and/or can specify similarities according to other conventions. In operation, the music service server 115 can identify songs that are similar according to the user or administrator organization. For example, if the electronic device 105 requests the music service server 115 to identify five songs that are similar to a seed song that happens to be a hip-hop song, the music service server 115 can identify five songs that are marked or tagged with a hip-hop attribute.

In other embodiments, the music service server 115 can examine listening data of one or more users to identify similar songs. In some cases, listening patterns between and among songs and users can indicate song similarities. For example, the listening data can indicate that users who listen to Song X also listen to Song Y; as a result, the music service server 115 can identify Song Y as similar to Song X, and/or vice-versa. It should be appreciated that other listening pattern and song similarity analyses are envisioned.

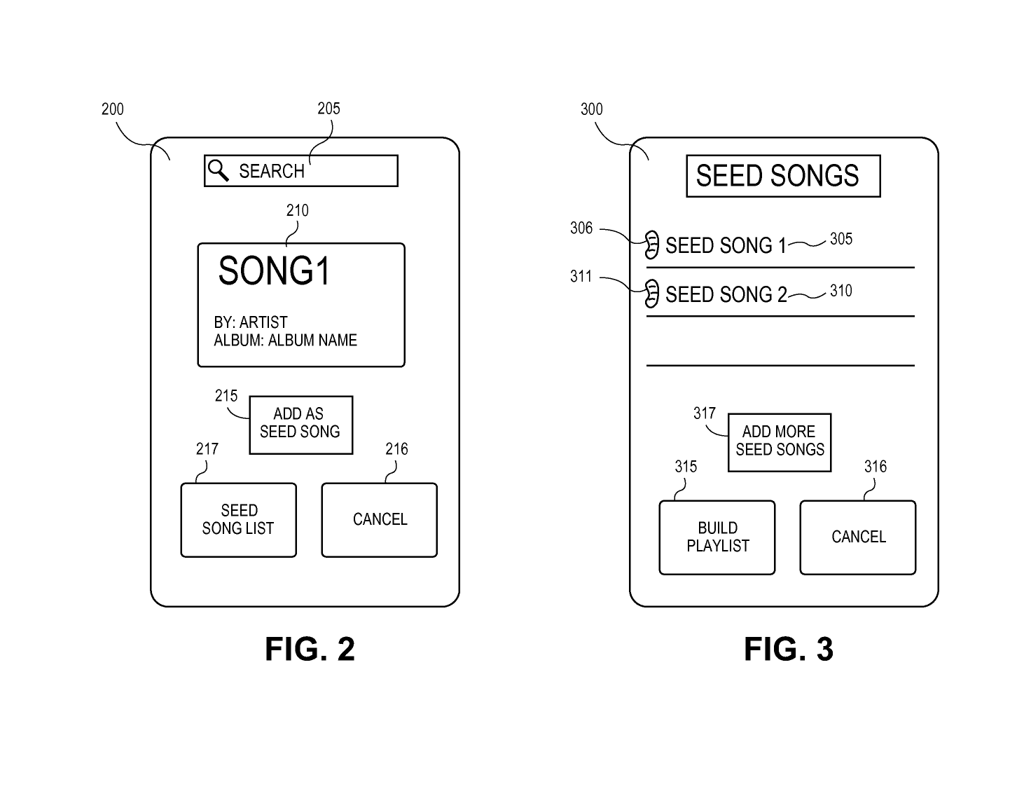

FIGS. 2, 3, and 4A-4D illustrate exemplary interfaces associated with the execution, facilitation, and implementation of the music service. More particularly, the exemplary interfaces can be screenshots associated with a music service application configured to facilitate functionalities of the music service and can be displayed on a device of the user, such as the device 105. The device can be configured to execute the music service application, and the interfaces of the music service application enable the user to provide input associated with various functionalities. The data associated with the exemplary interfaces can be transmitted to, received from, and/or synchronized with a server, such as the music service server 115. The user can interface with the music service application via a user interface of the device, such as a touchscreen. It should be appreciated that the interfaces of FIGS. 2, 3, and 4A-4D are merely exemplary and can comprise other various details and/or elements.

Referring to FIG. 2, depicted is an exemplary screenshot of a search interface 200 of a music service that enables users to locate seed songs for a playlist. As shown in FIG. 2, the search interface 200 includes a search bar 205 into which a user can input search parameters. For example, the user can input an artist name, a song title, a genre, an album title, an identification of a playlist, and/or other parameters. The music service can search a database of songs according to the search parameters entered into the search bar 205 and can identify one or more songs that match the search parameters. It should be appreciated that songs can be located according to other techniques, such as via browsing artists, albums, songs, playlists, feeds of other users, and/or the like.

The search interface 200 can present an indication 210 of an identified song. For example, as shown in FIG. 2, the indication 210 displays “SONG 1” that can match any search parameters that the user inputs into the search bar 205. The indication 210 can include additional information such as artist name, album title, genre, and/or other information. In embodiments, the music service application can suggest, recommend, or otherwise locate songs without the user inputting any search parameters. For example, the music service application can recommend songs based on a music profile of the user. According to embodiments, the user can select an add selection 215 to add the song identified by the indication 210 as a seed song for the playlist generation functionalities as discussed herein. The search interface 200 can further include a cancel selection 216 that enables the user to exit the search interface 200, search for an additional song, or return to a previous interface screen of the music service. Further, the search interface 200 can include a seed song list selection 217 that enables the user to navigate to a listing of the selected seed songs. It should be appreciated that the user can search for or otherwise select multiple songs that can be used as seed songs for the playlist generation functionalities. It should further be appreciated that in addition to the music service application adding songs to a new seed song list, the user can select to have the music service application add songs to existing seed song lists or playlists (e.g., “add to Playlist XYZ”). Further, users can select to add songs to new or existing seed song lists from any browsing or searching interface.

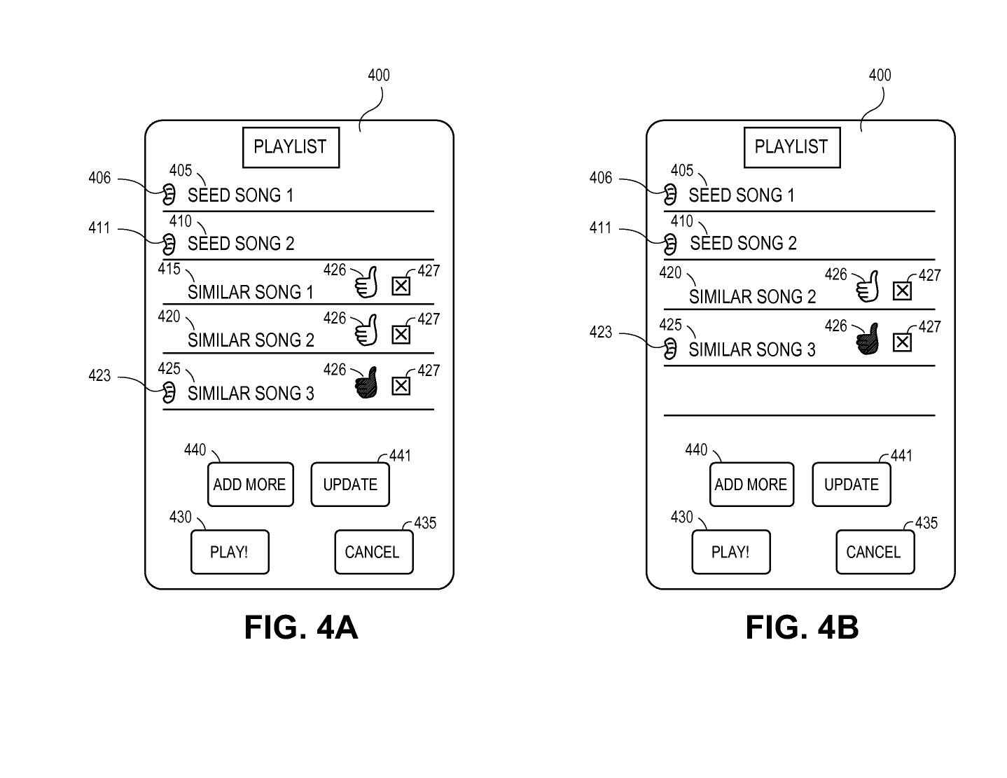

Referring to FIG. 3, depicted is a seed song interface 300 of the music service application according to embodiments. In particular, the seed song interface 300 lists each of the songs that the user selects as the seed songs from which to generate a playlist. In some embodiments, the music service application can display the seed song interface 300 in response to a user selecting the seed song list selection 217. In other embodiments, the music service can display the seed song interface 300 in response to the user selecting one or more seed songs for playlist generation.

As shown in FIG. 3, the seed song interface 300 lists “SONG 1” 305 and “SONG 2” 310 as seed songs that the user selected as seed songs and from which the music service application is to generate the playlist. The seed song interface 300 further includes optional indications 306, 311 that indicate that “SONG 1” 305 and “SONG 2” 310 are, in fact, seed songs. It should be appreciated that the indications 306, 311 are merely exemplary and can be depicted as other indications. In some embodiments, the music service can identify the seed songs in the seed song interface 300 independent or separate from the user selecting any seed songs. For example, the music service can populate the seed song interface 300 with songs that the user plays often, with random songs, or according to other selection techniques. The seed song interface 300 further includes an add more selection 317. In operation, if the user selects the add more selection 317, the music service application can display the search interface 200 to enable the user to search for and identify additional seed songs.

As shown in FIG. 3, the interface further includes a build playlist selection 315. In operation, if the user selects the build playlist selection 315, the music service application identifies songs that are similar to the indicated seed songs (e.g., 305 and 310) and that are to be added to a playlist. In particular, the music service application can receive a selection of the build playlist selection 315 by the user and, in response to receiving the selection, can identify the songs that are similar to the seed songs (305, 310) of the seed song interface 300. According to embodiments, the music service application can identify the similar songs based on the attributes of the songs and/or the similarity degrees or levels of the songs as discussed herein, or according to any technique, algorithm, tagging functionality, and/or the like. The interface can further include a cancel selection 316 that enables the user to exit the seed song interface 300 or return to a previous interface screen of the music service.

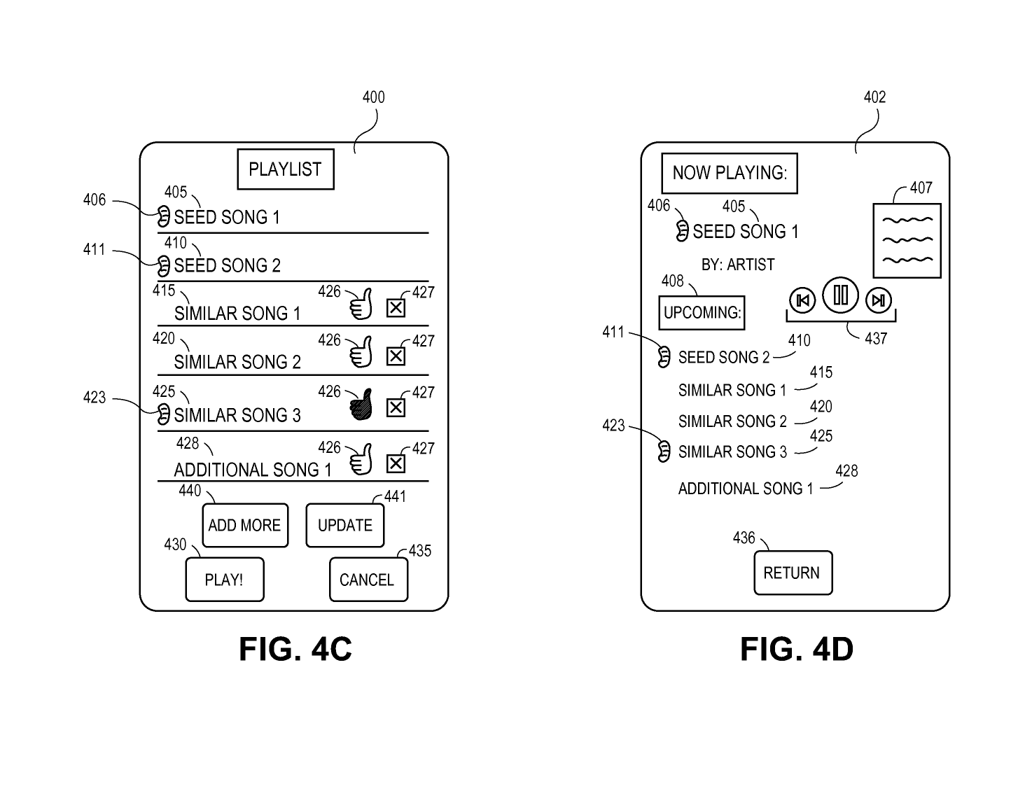

Referring to FIG. 4A, depicted is a playlist interface 400 of the music service application according to embodiments. In some embodiments, the music service application can identify the songs of the playlist interface 400 and display the playlist interface 400 in response to a user selecting the build playlist selection 315. The playlist interface 400 lists the seed songs that are selected by the user, namely, “SEED SONG 1” 405 and “SEED SONG 2” 410 (and includes corresponding seed indications 406, 411). In embodiments, the user can select the seed songs according to the functionality as described with respect to FIG. 2. Further, the playlist interface 400 lists the songs that the music service application identifies as being similar to the seed songs. Particularly, the playlist interface 400 lists “SIMILAR SONG 1” 415, “SIMILAR SONG 2” 420, and “SIMILAR SONG 3” 425 as the songs identified by the music service application that are similar to “SEED SONG 1” 405 and “SEED SONG 2” 410. It should be appreciated that the music service application can identify any amount of similar songs. In embodiments, the amount of similar songs can be set to a default value, can be set or adjusted by a user, or can be set according to other conventions.

As shown in FIG. 4A, the playlist interface 400 can also indicate feedback selections 426, 427 that enable the user to select or provide feedback for individual songs on the playlist 400. Particularly, the feedback selection 426 is depicted as a “thumbs up” and is accordingly associated with a positive rating (and with converting the selected song into a seed song), and the feedback selection 427 is depicted as an “X” and is accordingly associated with a selection to remove the corresponding song. It should be appreciated that the feedback selection 426, 427 can be depicted according to other conventions. For example, the feedback selections 426, 427 can be up and down arrows and/or can include text. For further example, the feedback selections 426, 427 can be a sliding scale that enables users to rate any of the songs of the playlist interface 400.

According to embodiments, the music service application can modify the songs of the playlist interface 400 according to the user selections of the feedback selections 426, 427. Particularly, if the user selects the “thumbs up” feedback selection 426 for a specific song, the music service application can convert that specific song into a seed song for the purpose of identifying additional songs. For example, as shown in FIG. 4A, the user selects the “thumbs up” feedback selection 426 for “SIMILAR SONG 3” 425, thus converting this song into a seed song (and accordingly causing the playlist interface 400 to display a corresponding seed indication 423). In embodiments as shown in FIG. 4A, the music service application can highlight the corresponding “thumbs up” feedback selection 426 for a specific song that the user converts into a seed song. In some cases, responsive to the user selecting to convert a song into a seed song, the music service application can identify one or more additional songs that are similar to the seed songs (i.e., “SEED SONG 1” 405, “SEED SONG 2” 410, and “SIMILAR SONG 3” 425). In embodiments, the music service application can add the additional songs to the playlist interface 400 in addition to the songs on the playlist interface 400. In other cases, the music service application can replace some of the non-seed songs on the playlist interface 400 with the additional songs.

According to embodiments, if the user selects the “X” feedback selection 427 for a specific song, the music service application can remove that specific song from the playlist interface 400. In some cases, in response to removing the specific song, the music service application can leave the playlist interface 400 as-is. In other cases, in response to removing the specific song, the music service application can identify an additional song that is similar to one or more of the seed songs on the playlist interface 400 and add the additional song to the playlist interface 400, such as if the user wants to maintain a certain amount of songs on the playlist interface 400.

In embodiments, a touchscreen of an electronic device on which the music service application is executing can display the playlist interface 400. In some cases, the user can rate or provide feedback for any of the songs according to any type of gesture. For example, if the user “double taps” a specific song on the playlist, the music service application can convert that song into a seed song and identify an additional song that is similar to the seed songs to add to the playlist (i.e., a “double tap” gesture constitutes as positive rating that converts a song into a seed song). For further example, if the user “swipes to remove” a specific song, the music service application can remove the specific song (and optionally replace the removed specific song with an additional identified song). It should be appreciated that other gestures associating with adding, removing, or rating songs are envisioned.

As shown in FIG. 4A, the playlist interface 400 includes a play selection 430 (“PLAY!”) and a cancel selection 435 (“CANCEL”). Particularly, in response to a user selecting the play selection 430, the music service application can initiate playback of the songs of the playlist interface 400. In embodiments, the order of the playback can be in an ordering as shown in FIG. 4A, in a random order, or in other orderings. Further, in response to a user selecting the cancel selection 435, the music service application exits the playlist interface 400, enables the user to search for additional songs, or returns to a previous interface screen. The playlist interface 400 further includes an add more selection 440 (“ADD MORE”). In embodiments, in response to a user selecting the add more selection 440, the music service application can identity one or more additional songs that are similar to any combination of the seed songs (405, 410, 425). It should be appreciated that the music service application can identify a set or variable amount of additional songs to add to the playlist interface 400 in response to detecting a selection of the add more selection 440.

As shown in FIG. 4A, the playlist interface 400 further includes an update selection 441 (“UPDATE”). In embodiments, the playlist interface 400 enables the user to select one or more of the “positive” feedback selection 426 (or one or more of the “X” feedback selection 427) corresponding to one or more of the similar songs (415, 420, 425) (e.g., by highlighting which of the feedback selections 426, 427 are selected), followed by enabling the user to select the update selection 441. In response, the music service application can identify songs that are similar to the seed songs (i.e., the original seed songs 405, 410 and any of the similar songs that are “marked” with the feedback selection 426) and/or remove the songs that are “marked” with the “X” feedback selection 427. For example, if the user selects the positive feedback selection 426 for “SIMILAR SONG 1” 415 and “SIMILAR SONG 3” 425 (thus converting the similar songs 415, 425 into seed songs), selects the “X” feedback selection 427 for “SIMILAR SONG 2” 420, and selects the update selection 441, the music service application can identify songs that are similar to the seed songs (i.e., “SEED SONG 1” 405, “SEED SONG 2” 410, “SIMILAR SONG 1” 415, and “SIMILAR SONG 3” 425) and can add the identified songs to the playlist, and can remove “SIMILAR SONG 2” 420 from the playlist. In some cases, the music service application can identify songs that are similar to either 1) the original seed songs (i.e., “SEED SONG 1” 405 and “SEED SONG 2” 410) or 2) the “converted” seed songs (i.e., “SIMILAR SONG 1” 415 and “SIMILAR SONG 3” 425). These cases can be useful when, for example, the converted seed songs do not share many characteristics or attributes with the original seed songs.

In some embodiments, the user may select multiple songs as original seed songs and the music service application can identify songs that are similar to individual of the original seed songs, for example in cases where the multiple original seed songs may have few similar attributes or characteristics. For example, the user can select three seed songs (song A, song B, song C) that are of different styles. Further, the music service can identify one or more songs that are similar to song A (e.g., song A1 and song A2), one or more songs that are similar to song B (e.g., song B1, song B2, and song B3), and one or more songs that are similar to song C (e.g., song C1 and song C2). When the user positively rates one of identified similar songs (thus converting the positively rated song into a seed song), the music service application can identify additional songs based on the converted seed song and the original seed song corresponding to the converted seed song. Referring back to the above example, if the user positively rates song B1, the music service application can identify one or more additional songs that are similar to song B1 and original seed song B. Further, if the user positively rates song C2, the music service application can identify one or more additional songs that are similar to song C2 and original seed song C.

Referring to FIG. 4B, depicted is the playlist interface 400 after the user has removed one of the songs on the playlist interface 400. Particularly, FIG. 4B depicts the playlist interface 400 after the user has removed “SIMILAR SONG 1” 415 as shown in FIG. 4A. For example, the user removes “SIMILAR SONG 1” 415 by selecting the “X” feedback selection 427 next to the song indication. In response to the user selecting the “X” feedback selection 427, the music service application removes “SIMILAR SONG 1” 415 from the playlist interface 400. In embodiments, the music service application can identify a song that is similar to one or more of the seed songs of the playlist (i.e., 405, 410, 425) to replace the removed song in the playlist.

Referring to FIG. 4C, depicted is the playlist interface 400 after the user has converted one of the songs on the playlist interface 400 into a seed song and the music service has identified a song that is similar to the seed songs. As shown in FIG. 4C, the user can positively rate “SIMILAR SONG 3” 425 by selecting the feedback selection 426 next to the song indication, whereby the music service application converts “SIMILAR SONG 3” 425 into a seed song. In response to the user selecting the rating selection 426 for “SIMILAR SONG 3” 425, the music service application identifies “ADDITIONAL SONG 1” 426, and adds the indication 426 of such to the playlist interface 400 as shown in FIG. 4C. According to embodiments, the music service application identifies “ADDITIONAL SONG 1” 428 as one that is similar to the seed songs. Continuing with the example, the music service application identifies “ADDITIONAL SONG 1” 428 as similar to “SEED SONG 1” 405, “SEED SONG 2” 410, and “SIMILAR SONG 3” 425. In some cases, the music service application can identify “ADDITIONAL SONG 1” 428 as similar to either 1) “SEED SONG 1” 405 and “SEED SONG 2” 410 or 2) “SIMILAR SONG 3” 425. In further cases, the music service application can identify “ADDITIONAL SONG 1” 428 as similar to “SIMILAR SONG 3” 425 and either “SEED SONG 1” 405 or “SEED SONG 2” 410, for example if “SEED SONG 1” 405 or “SEED SONG 2” 410 have few common characteristics or attributes.

In embodiments, the music service application can replace one of the remaining songs that is not a seed song (e.g., 415 or 420) with the “ADDITIONAL SONG 1” 428, for example if the playlist interface 400 maintains a set amount of songs. In some embodiments, the music service application can build the playlist such that a specific song is not repeatedly included in the playlist. For example, if a user negatively rates a specific song in building a playlist (and that song is removed from the playlist), the music service application can refrain from adding this specific song to the playlist at a later point in time. For further example, the music service application can refrain from adding a song to a playlist that already includes that song.

Referring to FIG. 4D, depicted is a playback interface 402 associated with the playlist interface 400. Particularly, the playback interface 402 includes a now playing 404 indication that indicates the song that the music service is playing. As shown in FIG. 4D, the music service application is playing “SEED SONG 1” 405. The now playing 404 indication can further indicate the artist of the song and/or any other metadata or information associated with the song such as, for example, album artwork 407.

The playback interface 402 further includes an upcoming songs section 408 that indicates any songs that are remaining in a playlist queue. As shown in FIG. 4D, the upcoming songs section 408 indicates songs 410, 415, 420, 425, and 426 as the remaining songs of the playlist queue. In embodiments, the music service application can play the songs in order as listed in the upcoming songs section 408, can play the songs in a random order, or can play the songs according to other playback conventions. The playback interface 402 can further include a return selection 436 that enables a user to navigate to any previous interface screen. Further, the playback interface 402 can include playback selections 437 that enable the user to control the playback functions of the songs of the playlist (e.g., play, pause, repeat, skip track, etc.).

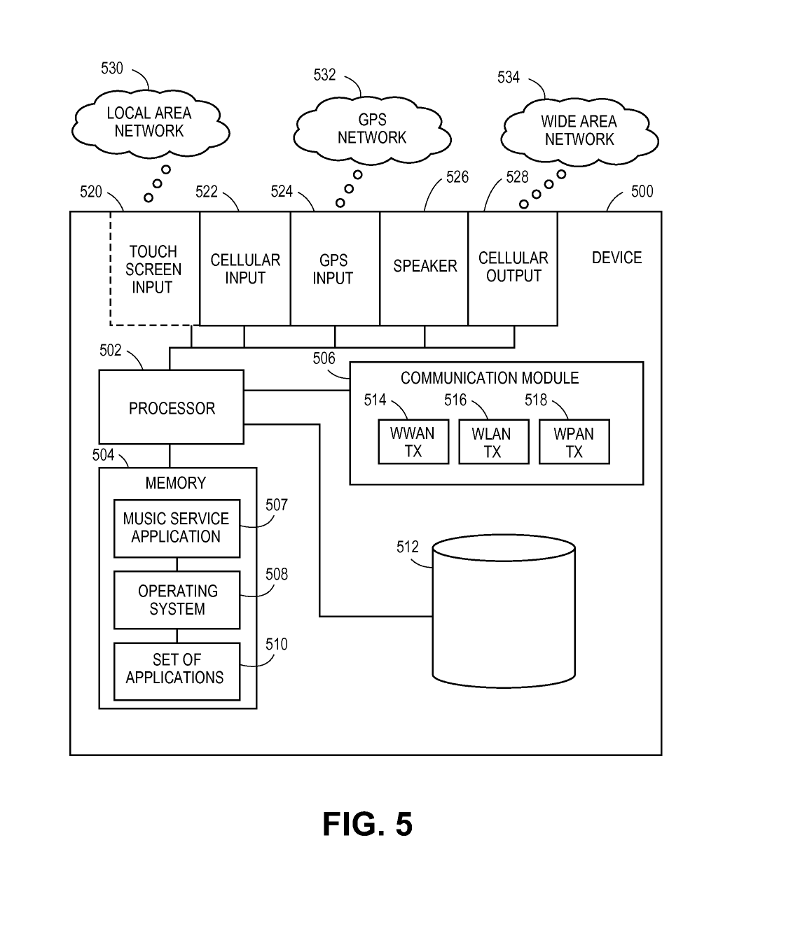

Referring to FIG. 5, depicted is an exemplary device 500 and components thereof. More particularly, a user can use the device 500 to access the music service to facilitate any functionalities as described herein. It should be appreciated that FIG. 5 represents a generalized schematic illustration and that other components can be added or existing components can be removed or modified.

As shown in FIG. 5, the device 500 can comprise a set of ports that can receive input signals or data from, or output signals or data to, other components of a media distribution environment, such as the environment 100 as discussed with respect to FIG. 1. More particularly, a cellular input port 522 can receive cellular data from a wide area network 534 (such as various private or public networks), a GPS input port 524 can receive GPS coordinate data from a GPS network 534, and a cellular output port 528 can output data to the wide area network 534. The device 500 can further comprise an optional touchscreen input port 520 that can receive inputs from interactions with a touchscreen by a user operating the device 500.

The device 500 can further comprise a processor 502 communicating with a memory 504, such as electronic random access memory (RAM), or other forms of transitory or non-transitory computer readable storage mediums, operating under control of or in conjunction with an operating system 508. The operating system 508 can be any commercial, open-source, or proprietary operating system or platform. The processor 502 can communicate with a database 512, such as a database stored on a local hard drive. While illustrated as a local database in the device 500, the database 512 can be separate from the device 500.

The processor 502 can further communicate with a communication module 506, such as a wired or wireless data connection, which in turn communicates with the wide area network 534. Further, the communication module 506 can comprise radio transceivers that communicate with a wireless local area network 530 or other networks, such as various personal area networks. The communication module 506 can comprise a WWAN transceiver 514 capable of communicating with the wide area network 534, a WLAN transceiver 516 capable of communicating with the local area network 530, and a WPAN transceiver 518 capable of communicating with a personal area network (such as a Bluetooth® network).

The set of ports 520, 522, 524, 526 of the device 500 can use the components of the communication module 506 to connect to the entities of the environment 100. For example, the cellular input port 522 can receive streaming song data via the WWAN transceiver 514. The processor 502 can also communicate with a set of applications 510 that can be configured to execute control logic and perform data processing to perform the functions and techniques as discussed herein. For example, the set of applications 510 can comprise a music service application 507 that can provide the interfaces as described herein, receive inputs from the user, and facilitate the communication of data among the entities of the environment 100. It should be appreciated that other applications 510 and functionalities thereof are envisioned.

While FIG. 5 illustrates the device 500 as a standalone system using a combination of hardware and software, the components of the device 500 can also be implemented as a software application or program capable of being executed by a conventional computer platform. Likewise, the components of the device 500 can also be implemented as a software module or program module capable of being incorporated in other software applications and programs. In either case, the components of the device 500 can be implemented in any type of conventional proprietary or open-source computer language.

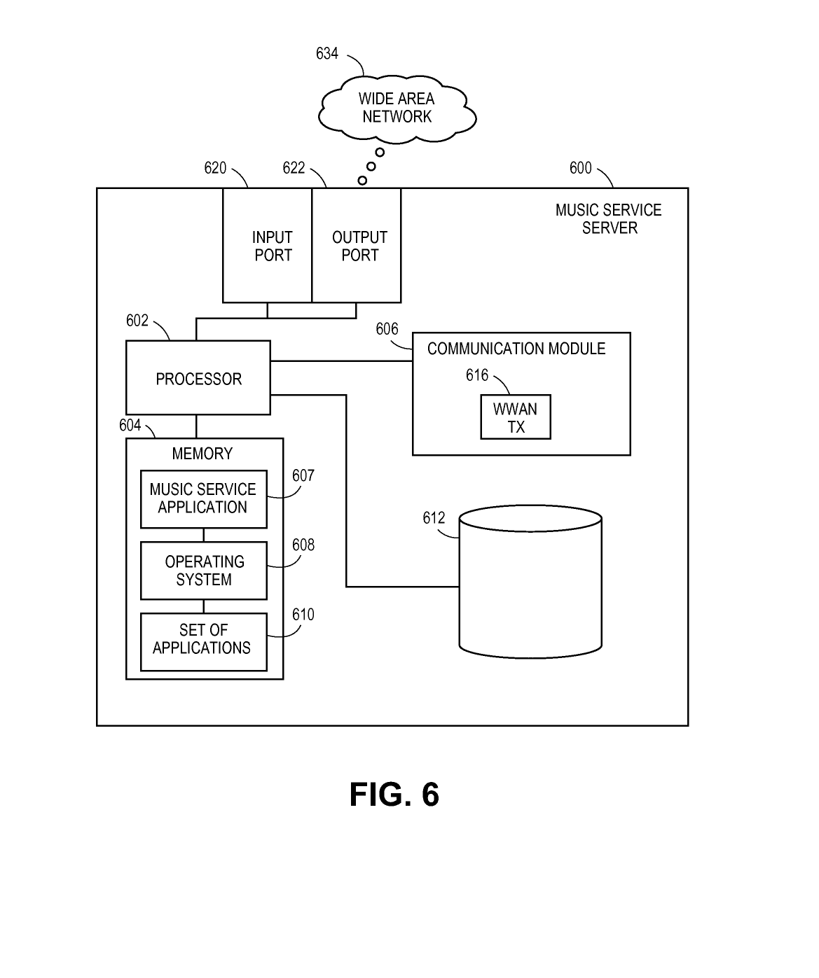

Referring to FIG. 6, depicted is an exemplary server and components thereof. More particularly, the server 600 can be the music service server 115 as discussed with respect to FIG. 1. It should be appreciated that FIG. 6 represents a generalized schematic illustration and that other components can be added or existing components can be removed or modified.

As shown in FIG. 6, the server 600 can comprise a set of ports that can receive input signals or data from, or output signals or data to, other components of a media distribution environment, such as the environment 100 as discussed with respect to FIG. 1. More particularly, an input port 620 can receive cellular or other types of data from a wide area network 634 (such as various private or public networks), and an output port 622 can output data to the wide area network 634, such as streaming music data.

The server 600 can further comprise a processor(s) 602 communicating with a memory 604, such as electronic random access memory (RAM), or other forms of transitory or non-transitory computer readable storage mediums, operating under control of or in conjunction with an operating system 608. The operating system 608 can be any commercial, open-source, or proprietary operating system or platform. The processor 602 can communicate with a database 612, such as a database stored on a local hard drive. While illustrated as a local database in the server 600, the database 612 can be separate from the server 600.

The processor 602 can further communicate with a communication module 606, such as a wired or wireless data connection, which in turn communicates with the wide area network 634. In particular, the communication module 606 can comprise a WWAN transceiver 616 capable of communicating with the wide area network 634. The set of ports 620, 622 of the server 600 can use the components of the communication module 606 to connect to the entities of the environment 100. For example, the input port 620 can receive playlist preference data via the WWAN transceiver 616, and the output port 622 can stream audio data via the WWAN transceiver 616. The processor 602 can also communicate with a set of applications 610 that can be configured to execute control logic and perform data processing to perform the functions and techniques as discussed herein. For example, the set of applications 610 can comprise a music service application 607 that can support the functionalities of the music service, such as the playlist generation functionalities, as described herein. It should be appreciated that other applications 610 and functionalities thereof are envisioned.

While FIG. 6 illustrates the server 600 as a standalone system using a combination of hardware and software, the components of the server 600 can also be implemented as a software application or program capable of being executed by a conventional computer platform. Likewise, the components of the server 600 can also be implemented as a software module or program module capable of being incorporated in other software applications and programs. In either case, the components of the server 600 can be implemented in any type of conventional proprietary or open-source computer language.

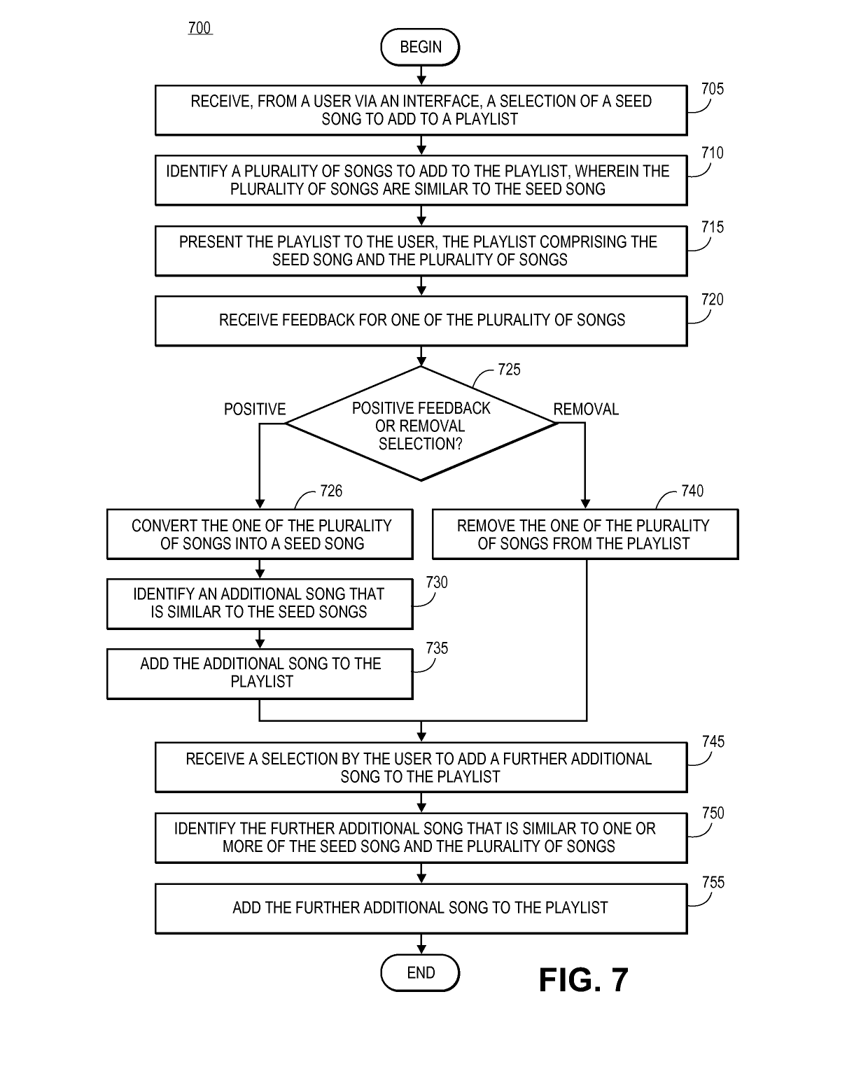

FIG. 7 is a flowchart of a method 700 for an electronic device (such as the device 105) to generate a playlist. It should be appreciated that the functionalities of the method 700 can be implemented with the device executing an application and interfacing with a remote server, such as the music service server 115. The method begins when the electronic device receives 705, from a user via an interface of the electronic device, a selection of a seed song to add to the playlist. According to embodiments, the user can select multiple songs as seed songs for the playlist.

The electronic device identifies 710 a plurality of songs to add to the playlist, wherein the plurality of songs are similar to the seed song. In embodiments, the electronic device compares musical properties of the seed song to those of any available songs, and can determine the plurality of songs based on a similarity of the musical properties. In some embodiments, the electronic device can examine listening data to identify songs that users typically enjoy if those users also enjoy the seed song. The electronic device presents 715 the playlist to the user, the playlist comprising the seed song and the plurality of songs. In some cases, the electronic device presents the playlist to the user as a listing of the songs, for example as illustrated in FIG. 4A. Further, the electronic device displays feedback selections next to or in a proximity to each of the plurality of songs, the feedback selections enabling users to positively rate or remove any of the plurality of songs, as discussed herein.

The electronic device receives 720 feedback for one of the plurality of songs. For example, the electronic device can receive a positive rating for the song or a selection to remove the song via a user selection of a corresponding feedback selection. In embodiments, the electronic device can receive the feedback by detecting various gestures (e.g., double tap, swipe to remove, etc.) or via other techniques. The electronic device determines 725 if the feedback is positive feedback or a selection to remove the one of the plurality of songs. For example, the feedback can be positive if the user selects a “thumbs up” selection or the feedback can be a removal selection if the user selects an “X” selection.

If the feedback is positive (“POSITIVE”), the electronic device converts 726 the one of the plurality of songs into a seed song. In embodiments, the electronic device can display an indication that the converted song is a seed song (such as the indication 423 as shown in FIG. 4A). The electronic device identifies 730 an additional song that is similar to the seed songs (including the original seed song and the song that was converted into the seed song). According to embodiments, the electronic device identifies the additional song by identifying a song with musical properties that are similar to those of the seed songs or by identifying a song with similar listening data to that of the seed songs. In some embodiments, the electronic device can identify the additional song as being similar to either the original seed song or the song that was converted into the seed song. The electronic device adds 735 the additional song to the playlist. In some cases, the electronic device adds the additional song to the playlist in addition to the songs already listed in the playlist. In other cases, the electronic device replaces one of the remaining songs on the playlist (e.g., one of the non-seed songs) with the additional song.

If the feedback is a removal selection (“REMOVAL”), the electronic device removes 740 the one of the plurality of songs from the playlist. In some cases, the electronic device can identify a replacement song that is similar to the seed song (e.g., via comparing musical properties) and can add the replacement song to the playlist. In embodiments, the electronic device can add the replacement song to the end of the playlist, to a location of the playlist previously occupied by the removed song, or to any other location of the playlist.

The electronic device receives 745 a selection by the user to add a further additional song to the playlist. For example, the user can select an “ADD MORE” option or similar selection of the interface. The electronic device identifies 750 the further additional song that is similar to the seed song(s). In embodiments, the electronic device can identify multiple additional songs in response to receiving the selection by the user. In some embodiments, the electronic device can identify the further additional song as one that is similar to either the original seed song or the song that was converted into the seed song. The electronic device adds 755 the further additional song to the playlist. In embodiments, the electronic device adds the further additional song to the end of the playlist or to any other location of the playlist. In some cases, the electronic device initiates a playback of the playlist in response to the user selecting to initiate the playback, in response to the playlist reaching a specified threshold, or in response to other triggers.

Thus, it should be clear from the preceding disclosure that the systems and methods offer improved playback generation techniques. The systems and methods advantageously allow users to discover new music, and to efficiently and effectively create playlists that include songs that are similar to songs that the users desire on the playlists.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method in an electronic device of generating a playlist, the method comprising:
receiving, from a user via an interface, a selection of a seed song to add to the playlist;
identifying, by a processor, a plurality of songs to add to the playlist, wherein the plurality of songs are similar to the seed song;
presenting the playlist to the user, the playlist comprising the seed song and the plurality of songs;
receiving, from the user, feedback for one of the plurality of songs; and
modifying the playlist according to the feedback for the one of the plurality of songs.

2. The method of claim 1, wherein if the feedback for the one of the plurality of songs is a removal selection, modifying the playlist comprises removing the one of the plurality of songs from the playlist.

3. The method of claim 1, wherein if the feedback for the one of the plurality of songs is positive, modifying the playlist comprises:
converting the one of the plurality of songs into an additional seed song;
identifying an additional song that is similar to at least one of the seed song and the additional seed song; and
adding the additional song to the playlist.

4. The method of claim 3, wherein identifying the additional song comprises:
removing another of the plurality of songs from the playlist; and
identifying the additional song to replace the another of the plurality of additional songs that was removed.

5. The method of claim 1, wherein receiving the feedback for the one of the plurality of songs comprises:
detecting a gesture by the user via the interface, the gesture corresponding to the one of the plurality of songs; and
determining, based on the gesture, whether the feedback for the one of the plurality of songs is positive or a removal selection.

6. The method of claim 1, further comprising:
receiving, from the user via the interface, a selection to add at least one additional song to the playlist;
identifying the at least one additional song that is similar to the seed song; and
adding the at least one additional song to the playlist.

7. The method of claim 1, further comprising:
receiving, from the user via the interface, a selection of an additional seed song to add to the playlist, wherein the plurality of songs are identified as similar to at least one of the seed song and the additional seed song.

8. An electronic device capable of generating a playlist for a user of a music service, the electronic device comprising:
an interface capable of receiving inputs from the user and presenting information to the user; and
a processor coupled to the user interface and configured to perform operations comprising:
receiving, from the user via the interface, a selection of a seed song to add to the playlist,
identifying a plurality of songs to add to the playlist, wherein the plurality of songs are similar to the seed song,
presenting the playlist to the user via the interface, the playlist comprising the seed song and the plurality of songs,
receiving, from the user, feedback for one of the plurality of songs, and
modifying the playlist according to the feedback for the one of the plurality of songs.

9. The electronic device of claim 8, wherein if the feedback for the one of the plurality of songs is a removal selection, modifying the playlist comprises removing the one of the plurality of songs from the playlist.

10. The electronic device of claim 8, wherein if the feedback for the one of the plurality of songs is positive, modifying the playlist comprises:
converting the one of the plurality of songs into an additional seed song;
identifying an additional song that is similar to at least one of the seed song and the additional seed song, and
adding the additional song to the playlist.

11. The electronic device of claim 10, wherein identifying the additional song comprises:
removing another of the plurality of songs from the playlist, and identifying the additional song to replace the another of the plurality of additional songs that was removed.

12. The electronic device of claim 8, wherein receiving the feedback the one of the plurality of songs comprises:
detecting a gesture by the user via the interface, the gesture corresponding to the one of the plurality of songs, and
determining, based on the gesture, whether the feedback for the one of the plurality of songs is positive or a removal selection.

13. The electronic device of claim 8, further comprising:
receiving, from the user via the interface, a selection to add at least one additional song to the playlist,
identifying the at least one additional song that is similar to the seed song, and
adding the at least one additional song to the playlist.

14. The electronic device of claim 8, further comprising:
receiving, from the user via the interface, a selection of an additional seed song to add to the playlist, wherein the plurality of songs are identified as similar to at least one of the seed song and the additional seed song.

15. A non-transitory computer readable medium comprising computer instructions embodied thereon to:
cause a processor to receive, from a user via an interface, a selection of a seed song to add to a playlist;
cause the processor to identify a plurality of songs to add to the playlist, wherein the plurality of songs are similar to the seed song;
cause the processor to present the playlist to the user via the interface, the playlist comprising the seed song and the plurality of songs;
cause the processor to receive, from the user, feedback for one of the plurality of songs; and
cause the processor to modify the playlist according to the feedback for the one of the plurality of songs.

16. The non-transitory computer readable medium of claim 15, wherein if the feedback for the one of the plurality of songs is a removal selection, causing the processor to modify the playlist comprises causing the processor to remove the one of the plurality of songs from the playlist.

17. The non-transitory computer readable medium of claim 15, wherein if the feedback for the one of the plurality of songs is positive, causing the processor to modify the playlist comprises:
causing the processor to convert the one of the plurality of songs into an additional seed song;
causing the processor to identify an additional song that is similar to at least one of the seed song and the additional seed song; and
causing the processor to add the additional song to the playlist.

18. The non-transitory computer readable medium of claim 15, wherein causing the processor to receive the feedback for the one of the plurality of songs comprises:
causing the processor to detect a gesture by the user via the interface, the gesture corresponding to the one of the plurality of songs; and
causing the processor to determine, based on the gesture, whether the feedback for the one of the plurality of songs is positive or a removal selection.

19. The non-transitory computer readable medium of claim 15, further comprising computer instructions embodied thereon to:
cause the processor to receive, from the user via the interface, a selection to add at least one additional song to the playlist;
cause the processor to identify the at least one additional song that is similar to the seed song; and
cause the processor to add the at least one additional song to the playlist.

20. The non-transitory computer readable medium of claim 15, further comprising computer instructions embodied thereon to:
cause the processor to receive, from the user via the interface, a selection of an additional seed song to add to the playlist, wherein the plurality of songs are identified as similar to at least one of the seed song and the additional seed song.
